(19) United States
(12) Patent Application Publication
(10) Pub. No.: US 2023/0145363 A1
(43) Pub. Date: May 11, 2023

(54) INTELLIGENT MENTOR AND EXPERTISE MATCHING TOOL

(71) Applicant: International Business Machines Corporation, Armonk, NY (US)

(72) Inventors: Jennifer M. Hatfield, San Francisco, CA (US); Madeline Clark, The Woodlands, TX (US); Michael Bender, Rye Brook, NY (US); Jeremy R. Fox, Georgetown, TX (US)

(21) Appl. No.: 17/453,820

(22) Filed: Nov. 5, 2021

(51) Int. Cl. G06Q 10/06; G06F 16/9535; G06F 16/951; G06Q 30/02

(52) U.S. Cl. CPC G06Q 10/063112; G06F 16/951; G06F 16/9535; G06Q 30/0203

(57) ABSTRACT

An apparatus for an mentor and expertise matching includes a profile module configured to populate a mentee profile in response to receiving information from the mentee. The mentee profile includes information about skills and preferences of the mentee. A scoring module compares information from the mentee profile with a plurality of mentor profiles from a mentor database to determine, using a mentor scoring algorithm, a mentor score for each of the plurality of mentor profiles. A selection module is configured to receive a mentee selection of a mentor from one or more mentors presented to the mentee. Each of the mentors presented to the mentee includes a higher mentor score than other mentors. A mentorship tracking module is configured to track interactions between the mentor and the mentee, and a mentor feedback module is configured to update a mentor profile of the mentor based on feedback from the interactions.

### BACKGROUND

The subject matter disclosed herein relates to identifying a mentor and more particularly relates to intelligent mentor and expertise matching.

### SUMMARY

An apparatus for an intelligent mentor and expertise matching tool is disclosed. A computer-implemented method and computer program product also perform the functions of the apparatus. According to an embodiment of the present invention, the apparatus includes a profile module configured to populate a mentee profile of a mentee in response to receiving, via a computing device, information from the mentee. The mentee profile includes information about skills and preferences of the mentee. The apparatus includes a scoring module configured to compare information from the mentee profile with a plurality of mentor profiles from a mentor database to determine, using a mentor scoring algorithm, a mentor score for each of the plurality of mentor profiles. The apparatus includes a selection module configured to receive, from the mentee via a computing device, a selection of a mentor from one or more mentors presented to the mentee. Each of the one or more mentors presented to the mentee includes a higher mentor score than other mentors of the mentor database. The apparatus includes a mentorship tracking module configured to track interactions between the selected mentor and the mentee, and a mentor feedback module configured to update a mentor profile of the selected mentor based on feedback from the interactions between the selected mentor and the mentee. At least a portion of said modules comprise one or more of hardware circuits, programmable hardware devices and executable code, the executable code stored on one or more non-transitory computer readable storage media.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for an intelligent mentor and expertise matching tool;

FIG. 2 is a schematic block diagram illustrating one embodiment of an apparatus for an intelligent mentor and expertise matching tool;

FIG. 3 is a schematic block diagram illustrating another embodiment of an apparatus for an intelligent mentor and expertise matching tool;

FIG. 4 is a schematic flow chart diagram illustrating one embodiment of a method for an intelligent mentor and expertise matching tool;

FIG. 5 is a schematic flow chart diagram illustrating another embodiment of a method for an intelligent mentor and expertise matching tool;

FIG. 6A is a first part of a schematic flow chart diagram illustrating a more detailed embodiment of a method for an intelligent mentor and expertise matching tool; and

FIG. 6B is a second part of the schematic flow chart diagram of FIG. 6A.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or “Flash memory”), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (“LAN”) or a wide area network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in software using program code for execution by various types of processors. An identified module of program instructions may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

The description of elements in each figure may refer to elements of proceeding figures. Like numbers refer to like elements in all figures, including alternate embodiments of like elements.

An apparatus for an intelligent mentor and expertise matching tool is disclosed. A computer-implemented method and computer program product also perform the functions of the apparatus. According to an embodiment of the present invention, the apparatus includes a profile module configured to populate a mentee profile of a mentee in response to receiving, via a computing device, information from the mentee. The mentee profile includes information about skills and preferences of the mentee. The apparatus includes a scoring module configured to compare information from the mentee profile with a plurality of mentor profiles from a mentor database to determine, using a mentor scoring algorithm, a mentor score for each of the plurality of mentor profiles. The apparatus includes a selection module configured to receive, from the mentee via a computing device, a selection of a mentor from one or more mentors presented to the mentee. Each of the one or more mentors presented to the mentee includes a higher mentor score than other mentors of the mentor database. The apparatus includes a mentorship tracking module configured to track interactions between the selected mentor and the mentee, and a mentor feedback module configured to update a mentor profile of the selected mentor based on feedback from the interactions between the selected mentor and the mentee. At least a portion of said modules comprise one or more of hardware circuits, programmable hardware devices and executable code, the executable code stored on one or more non-transitory computer readable storage media.

In some embodiments, each mentor profile in the mentor database includes a plurality of mentor categories and each mentor category includes a category score and the mentor feedback module updates the mentor profile based on feedback from the interactions between the selected mentor and the mentee by adjusting the category score in one or more of the plurality of mentor categories. In a further embodiment, the category score of each of the mentor categories of a mentor profile affects the mentor score of the mentor profile when the scoring module compares a mentee profile with the mentor profile. In other embodiments, the mentorship tracking module includes a mentee survey module configured to present, via an electronic display of a computing device, a mentorship survey to the mentee regarding interactions between the mentee and the selected mentor. The mentor feedback module uses the information provided by the mentee in response to receiving the mentee survey to update the mentor profile of the selected mentor. In other embodiments, the mentorship tracking module includes a mentor communication module configured to track frequency and content of interactions between the mentee and the selected mentor. The mentor feedback module uses the frequency and the content of the interactions between the mentee and the selected mentor to update the mentor profile of the selected mentor.

In some embodiments, the apparatus includes a profile scraping module configured to further populate the mentee profile by scraping information from one or more social media accounts of the mentee. In other embodiments, the apparatus includes a profile analysis module configured to analyze mentee skills in one or more fields of study and/or one or more learning methods of the mentee from information in the mentee profile to identify a skill to be improved for the mentee and one or more preferred learning methods of the mentee. The scoring module uses the identified skill to be improved for the mentee and the one or more preferred learning methods of the mentee for comparison with the mentor profiles. In other embodiments, the scoring module uses preferences from the mentee and the identified skill to be improved for the mentee and the one or more preferred learning methods of the mentee to adjust weighting of the information of the mentee profile. In other embodiments, the profile analysis module uses a mentee profile machine learning algorithm to refine over time analysis of the mentee skills and learning methods based on a plurality of mentee profiles, information from a plurality of mentees, and/or social media information from the plurality of mentees.

In some embodiments, the mentee profile and the mentor profiles each include location information and the scoring module uses the location information in determining a mentor score for each of the plurality of mentor profiles. In other embodiments, the mentor feedback module uses a mentor machine learning algorithm to update the mentor profile of each of a plurality of selected mentors based on feedback from the interactions between each of the plurality of selected mentors and a corresponding mentee. The mentor machine learning algorithm uses feedback from mentees and/or information about interactions between the mentees and corresponding selected mentors to refine information in each of the mentor profiles of the selected mentors.

In some embodiments, the apparatus includes a mentor identification module configured to identify potential mentors without a mentor profile in the mentor database, a mentor request module configured to send, over a computer network, an invitation to the potential mentor to be a mentor, and a mentor profile module configured to create a mentor profile in the mentor database in response to receiving consent from the potential mentor. The mentor profile is created from information about the potential mentor received from the potential mentor and/or publicly available information.

A computer-implemented method includes populating, using a processor, a mentee profile of a mentee in response to receiving, via a computing device, information from the mentee. The mentee profile includes information about skills and preferences of the mentee. The computer-implemented method includes comparing, using a processor, information from the mentee profile with a plurality of mentor profiles from a mentor database to determine, using a mentor scoring algorithm executing on the processor, a mentor score for each of the plurality of mentor profiles and receiving, from the mentee via a computing device, a selection of a mentor from one or more mentors presented to the mentee. Each of the one or more mentors presented to the mentee includes a higher mentor score than other mentors of the mentor database. The computer-implemented method includes tracking, using a processor, interactions between the selected mentor and the mentee, and updating, using a processor, a mentor profile of the selected mentor based on feedback from the interactions between the selected mentor and the mentee.

In some embodiments, each mentor profile in the mentor database includes a plurality of mentor categories and each mentor category includes a category score and updating a mentor profile of the selected mentor based on feedback from the interactions between the selected mentor and the mentee includes adjusting the category score in one or more of the plurality of mentor categories. The category score of each of the mentor categories of a mentor profile affects determining a mentor score. In other embodiments, tracking interactions between the selected mentor and the mentee includes presenting, via an electronic display of a computing device, a mentorship survey to the mentee regarding interactions between the mentee and the selected mentor. Updating a mentor profile of the selected mentor includes using the information provided by the mentee in response to receiving the mentee survey to update the mentor profile of the selected mentor. In other embodiments, the computer-implemented method includes tracking frequency and content of interactions between the mentee and the selected mentor. Updating a mentor profile of the selected mentor includes using the frequency and the content of the interactions between the mentee and the selected mentor to update the mentor profile of the selected mentor.

In some embodiments, the computer-implemented method includes analyzing mentee skills in one or more fields of study and/or one or more learning methods of the mentee from information in the mentee profile to identify a skill to be improved for the mentee and one or more preferred learning methods of the mentee. Determining the mentor score includes using the identified skill to be improved for the mentee and the one or more preferred learning methods of the mentee for comparison with the mentor profiles. In a further embodiment, the computer-implemented method includes using a mentee profile machine learning algorithm to refine over time analysis of the mentee skills and learning methods based on a plurality of mentee profiles, information from a plurality of mentees, and/or social media information from the plurality of mentees. In other embodiments, updating a mentor profile of the selected mentor includes using a mentor machine learning algorithm to update the mentor profile of each of a plurality of selected mentors based on feedback from the interactions between each of the selected mentors and a corresponding mentee. The mentor machine learning algorithm uses feedback from mentees and/or information about interactions between the mentees and corresponding selected mentors to refine information in each of the mentor profiles of the selected mentors.

A computer program product for mentor selection includes a non-transitory computer readable storage medium having program instructions embodied therewith. The program instructions are executable by a processor to cause the processor to populate a mentee profile of a mentee in response to receiving, via a computing device, information from the mentee. The mentee profile include information about skills and preferences of the mentee. The program instructions are executable by a processor to cause the processor to compare information from the mentee profile with a plurality of mentor profiles from a mentor database to determine, using a mentor scoring algorithm executing on the processor, a mentor score for each of the plurality of mentor profiles and receive, from the mentee via a computing device, a selection of a mentor from one or more mentors presented to the mentee. Each of the one or more mentors presented to the mentee include a higher mentor score than other mentors of the mentor database. The program instructions are executable by a processor to cause the processor to track interactions between the selected mentor and the mentee, and update a mentor profile of the selected mentor based on feedback from the interactions between the selected mentor and the mentee.

In some embodiments, each mentor profile includes a plurality of mentor categories and each mentor category includes a category score and updating a mentor profile of the selected mentor based on feedback from the interactions between the selected mentor and the mentee includes adjusting the category score in one or more of the plurality of mentor categories. The category score of each of the mentor categories of a mentor profile affects determining the mentor score.

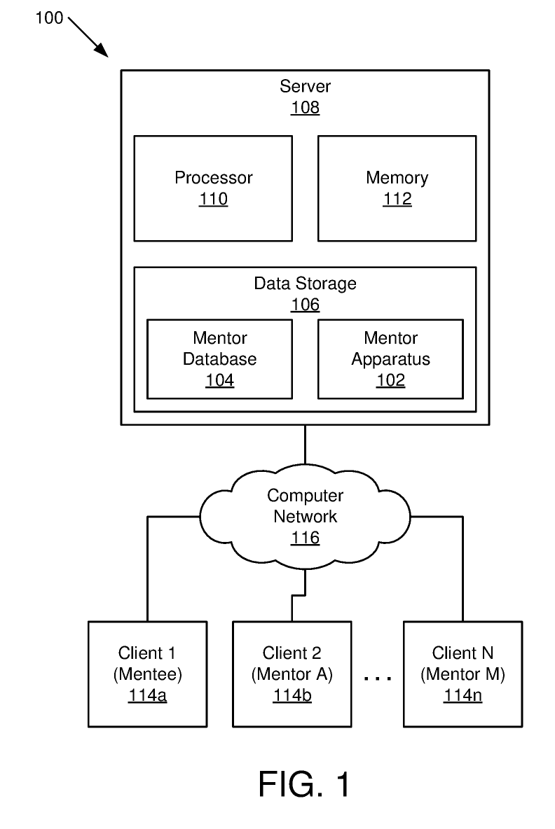

FIG. 1 is a schematic block diagram illustrating one embodiment of a system 100 for intelligent mentor and expertise matching. The system 100 includes a mentor apparatus 102 and a mentor database in a data storage device 106 of a server 108, that also includes a processor 110 and memory 112, clients 1-n 114a-n and a computer network 116, which are described below.

The system 100 includes a mentor apparatus 102 for intelligent mentor and expertise matching. The mentor apparatus 102 populates a mentee profile for a user that wants to be mentored (“mentee”) after receiving, via a computing device, information from the mentee, such as an area of interest, current skill level in the area of interest, preferred learning methods, etc. along with a desire to identify a mentor. The mentee profile includes information about skills and preferences of the mentee, and may include other information, such as contact information of the mentee, an email address, a location of the mentee, etc.

The mentor apparatus 102 compares information from the mentee profile with several mentor profiles located in the mentor database 104 to determine a mentor scores for each of the several mentor profiles. The mentor apparatus 102 uses a mentor scoring algorithm to determine the mentor score for each mentor profile. The mentor scoring system may compare information in various categories included in the mentee and mentor profiles to determine a mentor score. In some embodiments, the mentor apparatus 102 analyzes one or more fields of study and/or learning methods in the mentee profile to identify one or more skills to be improved for the mentee and one or more preferred learning methods of the mentee. The mentor apparatus 102 uses the identified skills to be improved and/or preferred learning methods when determining mentor scores.

The mentor apparatus 102 receives from the mentee, via a computing device, a selection of a mentor from one or more potential mentors. In some embodiments, the mentor apparatus 102 presents one or more potential mentors to the mentee that each have a mentor score higher than the mentor scores of other potential mentors. The mentor apparatus 102 then tracks interactions between the mentee and the selected mentor. Interactions may include information sent by the selected mentor to the mentee, meetings of the mentee and selected mentor, instructional material send by the mentor, etc.

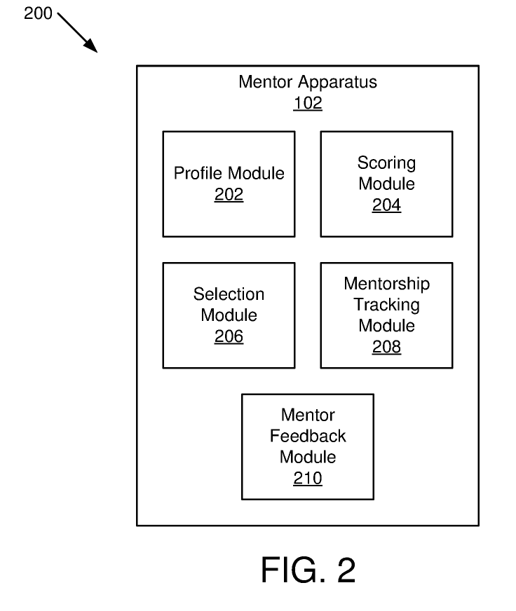

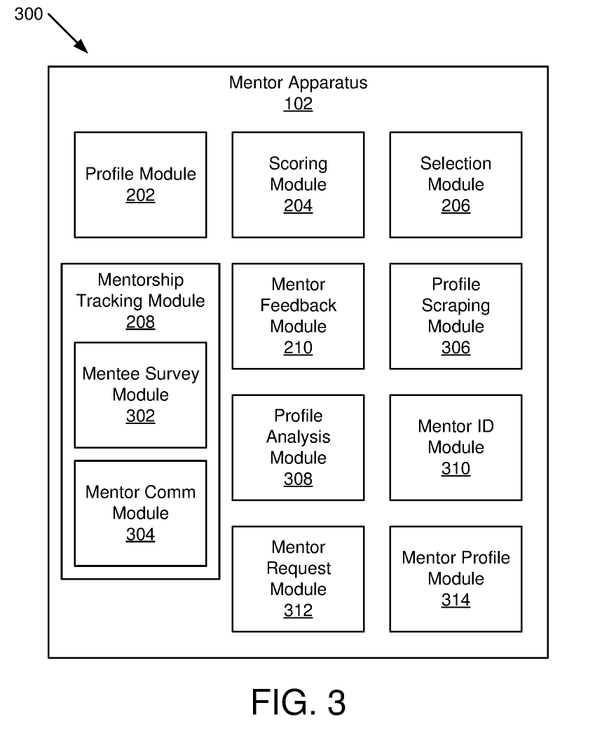

The mentor apparatus 102 updates the mentor profile of the selected mentor based on the interactions between the mentee and selected mentor, which then affects further mentor scores of the mentor profile of the selected mentor. In some embodiments, the mentor apparatus 102 sends a mentor survey to the mentee at various time during the mentorship or at the end of the mentorship and information received by the mentor apparatus 102 from the mentee in response to the mentor survey is then used by the mentor apparatus 102 to update the mentor profile of the selected mentor. In other embodiments, the mentor apparatus 102 analyzes frequency of interactions between the mentee and selected mentor, content of communications between the mentee and selected mentor, or the like to update the mentor profile of the selected mentor. The mentor apparatus 102 is describe in more detail in relation to the apparatuses 200, 300 of FIGS. 2 and 3.

The system 100 includes a mentor database 104 that includes mentor profiles. In some embodiments, the mentor database 104 also includes mentee profiles. The mentee profiles, in some embodiments, are segregated from the mentor profiles. In other embodiments, the mentee profiles include a tag or other indicator that distinguishes the mentee profiles from mentor profiles. The mentor profiles, in some embodiments, includes various categories, classifications, etc. to segregate information in the mentor profiles. For example, the mentor profiles may include broad categories, such as fields of study, skills, education information, work experience, teaching styles, and the like. In other embodiments, one or more of the broad categories include subcategories. For example, a particular field of study may include subcategories that pertain to the field of study. In some embodiments, the mentee profiles include categories and the mentor scoring algorithm maps categories and/or subcategories of the mentee profile of the mentee seeking a mentor with categories and/or subcategories of the mentor profiles. The mentor database 104, in various embodiments, is structured as a table, a list, a database or any other data structure known to those of skill in the art appropriate for mentor profiles and/or mentee profiles.

The server 108 is depicted with a data storage device 106 that includes the mentor apparatus 102 and the mentor database 104. The data storage device 106 is non-volatile storage and is non-transitory. While the data storage device 106 is depicted in the server 108, in other embodiments, the data storage device 106 is external to the server 108 but is accessible to the server 108. In some embodiments, the data storage device 106 is part of a storage area network (“SAN”). In other embodiments, the data storage device 106 is solid-state storage. In other embodiments, the data storage device 106 includes one or more hard disk drives (“HDD”), optical drives, etc. In some embodiments, the data storage device 106 includes two or more devices.

In some embodiments, the mentor apparatus 102 is embodied by program code and may be loaded on the data storage deice 106 from a tangible non-volatile storage device, which is an article of manufacture. In some embodiments, the mentor database 104 is set up by the mentor apparatus 102 as a data structure on the data storage device 106.

The server 108 includes a processor 110 and memory 112. The processor 110 may include one or more cores and/or one or more processors capable of executing code of the mentor apparatus 102. In some embodiments, the processor 110 loads portions or all of the mentor apparatus 102 and/or mentor database 104 into the memory 112. In other embodiments, the mentor apparatus 102 is implemented in a different form, such as a programmable hardware device. One of skill in the art will recognize other ways to implement the mentor apparatus 102.

The server 108, in various embodiments, is a rack-mounted server, a blade server, a compute node, a mainframe computer, a workstation, a desktop computer, or other suitable computing device. In some embodiments, the server 108 is part of a cloud computing solution and the mentor apparatus 102 executes on a virtual machine (“VM”) on one or more servers 108.

The server 108 is accessible by one or more clients 1-n 114a-n (generically or collectively “client 114” or “clients 114”). The clients 114 may be used by mentees and mentors to interact with the mentor apparatus 102. For example, a mentee may access a client 114 to connect with the server 108 to request a mentor, to input information to be included the mentee profile for the mentee, to provide feedback while being mentored or after being mentored, etc. A mentor may use another client 114 to input information to be in the mentor profile for the mentor, to communicate with the mentee, etc.

In various embodiments, a client 114 is a laptop computer, a desktop computer, a tablet computer, a smartphone, or other device capable of connecting with the server 108 over the computer network 116. In some embodiments, the mentor and/or selected mentee use different clients 114 at different times. For example, a mentee may initiate a request to be mentored using a laptop computer and may communicate with a selected mentor using a smartphone. A client 114 is any computing device capable of connecting to the server 108 to access the mentor apparatus 102.

The system 100 includes a computer network 116 that connects the clients 114 operated by a mentor and/or mentee to the mentor apparatus 102 through the server 108. The computer network 116, in various embodiments, include a local area network (“LAN”), a wide area network (“WAN”), a fiber optic network, a wireless connection, the Internet, etc. or any combination of networks. The computer network 116 includes, in various embodiments, servers, cabling, routers, switches, and the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

FIG. 2 is a schematic block diagram illustrating one embodiment of an apparatus 200 for intelligent mentor and expertise matching. The apparatus 200 includes one embodiment of the mentor apparatus 102 that includes a profile module 202, a scoring module 204, a selection module 206, a mentorship tracking module 208, and a mentor feedback module 210, which are described below. In some embodiments, the mentor apparatus 102 is implemented in code stored on a computer readable storage device. As used herein, computer readable storage devices are non-transitory. In other embodiments, all or a portion of the mentor apparatus 102 is implemented with a programmable hardware device and/or hardware circuits.

The apparatus 200 includes a profile module 202 configured to populate a mentee profile of a mentee in response to receiving, via a computing device, information from the mentee. In some embodiments, the computing device is a client (e.g. 114a). The mentee profile includes information about skills and preferences of the mentee. In some embodiments, information in the mentee profile is received from the mentee. In other embodiments, some of the information in the mentee profile is received from another source, such as another person, from social media, etc.

In some embodiments, the mentee profile includes skill information about the mentee, such as education information, training courses, certifications, etc. for the mentee. In other embodiments, the mentee profile includes information about one or more preferred learning methods of the mentee. Learning methods may include learning through the use of videos, emails, online material, in-person visits, telephone calls, etc. or a combination thereof. In some embodiments, the learning methods are ranked by the mentee or through machine learning based on interactions with one or more mentors. In other embodiments, the mentee profile includes personal information about the mentee, such as location information, an address, phone number, email address, social media account information, hobbies of the mentee, and the like. In some embodiments, the mentee profile includes one or more skills, subjects, interests, etc. where the mentee wants improvement through the use of a mentor. As used herein, the term “skills” includes skills, talents, subjects, interests, etc. of the mentee.

The apparatus 200 includes a scoring module 204 configured to compare information from the mentee profile with a plurality of mentor profiles from a mentor database 104 to determine, using a mentor scoring algorithm, a mentor score for each of the plurality of mentor profiles. In some embodiments, the scoring module 204 compares the mentee profile with a plurality of mentor profiles, but not all of the mentor profiles in the mentor database 104. For example, some of the mentor profiles in the mentor database 104 may be eliminated by the scoring module 204 based on a category, a field, a location, etc. of the mentor profiles prior to comparing and scoring the eliminated mentor profiles. In other embodiments, the scoring module 204 compares the mentee profile with each mentor profile in the mentor database 104.

The mentor scoring algorithm, in some embodiments, compares a score in some or all of the categories and/or subcategories of the mentor profiles with corresponding information from the mentee profile. For example, the mentee profile may want to improve a skill level of the mentee in a particular programming language and each mentor profile may include a skill from 1 to 10 of the mentor and the mentor scoring algorithm at least partially calculates a mentor score for each mentor profile based on the skill level for the programming language. In some embodiments, the mentor scoring algorithm includes multiple factors when determining a mentor score for a mentor profile. In some examples, the mentor scoring algorithm creates a mentor score based on a desired skill to be improved, location of the mentor with respect to the mentee, preferred learning method of the mentee compared with teaching methods of the mentor, etc. The mentor scoring algorithm, in some embodiments, has a weighting for each factor, which may be influenced by information from the mentee.

In some embodiments, the mentor scoring algorithm is adjusted over time using a machine learning algorithm. In some examples, the machine learning algorithm includes a deep neural network that includes various mentor profiles, mentee profiles, mentee preferences, interactions between the mentor and mentee, etc. as input where output of the deep neural network includes weighting of the multiple factors, scores of the mentors in various skills, and the like. For example, the machine learning algorithm may be trained with initial information and then may update the mentor scoring algorithm over time as more information about mentorships is input to the deep neural network.

The apparatus 200 includes a selection module 206 configured to receive a selection of a mentor from one or more mentors presented to the mentee. Typically, the selection module 206 receives a selection from the mentee via a computing device such as a client 114. Each of the one or more mentors are presented to the mentee have a higher mentor score than other mentors of the mentor database 104. For example, the selection module 206 may present mentors that have the top 10 highest mentor scores. The selection module 206 may present a different number of mentors. The mentors are presented via an electronic in communication with the client 114 used by the mentee and the mentee selects a mentor presented to the mentee with an input/output (“IO”) device connected to the client 114.

The selection module 206 receives information about which mentor was selected by the mentee and starts a process of connecting the selected mentor with the mentee so that the selected mentor can begin mentoring the mentee. In some embodiments, the selection module 206 presents information about the mentee to the mentor or information about the mentor to the mentee via an application associated with the mentor apparatus 102. In other embodiments, the selection module 206 sends information about the mentor to the mentee or vice-versa using other electronic means, such as by email, by direct messaging, by text messaging, etc. In some embodiments, the selection module 206 provides access to the mentee and/or mentor to information, services, data, etc. that will more easily facilitate mentoring by the mentor.

In some embodiments, the selection module 206 communicates to the mentor that the mentee has selected the mentor for a mentorship. In some embodiments, the selection module 206 receives, from the selected mentor, an acceptance or a rejection of the mentee and then communicated the acceptance or rejection to the mentee. In cases where the mentor sends an acceptance, in some embodiments, the selection module 206 and/or mentor apparatus 102 then commences with exchanging information about the mentee to the mentor and vice-versa, commences with unlocking resources for the mentee and/or mentor, and the like.

The apparatus 200 includes a mentorship tracking module 208 configured to track interactions between the selected mentor and the mentee. In some embodiments, the mentorship tracking module 208 tracks interactions through an application available to the selected mentor and to the mentee. For example, the mentor apparatus 102 may include an application with an interface that facilitates collaboration between the selected mentor and the mentee and the mentorship tracking module 208 tracks interactions based on the collaboration interface. In other embodiments, the mentorship tracking module 208 tracks interactions based on input from the mentee and/or the selected mentor.

In other embodiments, the mentorship tracking module 208 tracks interactions by tracking emails, texts or other correspondence between the selected mentor and the mentee. In other embodiments, the mentorship tracking module 208 tracks interactions from log information from the mentee and/or selected mentor. For example, the mentorship tracking module 208, in some instances, provides a logging feature where the mentee and/or selected mentor inputs meeting information, documents communicated, phone calls, texts and other interactions. One of skill in the art will recognize other ways for the mentorship tracking module 208 to track interaction between the mentee and the selected mentor.

The apparatus 200 includes a mentor feedback module 210 configured to update a mentor profile of the selected mentor based on feedback from the interactions between the selected mentor and the mentee. The mentor profile of the selected mentor is in the mentor database 104. The mentor feedback module 210 updates the mentor profile to reflect the quality of the mentorship, timeliness of interactions, methods of communication with the mentee, and the like to provide a better picture of the strengths and weaknesses of the mentor in various areas. The mentor feedback module 210 updates the mentor profile in a way that affects future mentor scores. For example, a score for timeliness in a mentor profile may be initially set to 5 out of 10. The mentor feedback module 210 may then increase the timeliness score to an 8 out of 10 based on the selected mentor providing help to the mentee in a timely manner. For a next mentee profile being compared to the updated mentor profile of the selected mentor, the mentor score would then increase with respect to timeliness.

In some examples, where the mentor communicates information via video, online meetings and email and does not communicate or rarely communicates via text messages, phone calls and hard copies of materials, the mentor feedback module 210 updates the methods of communication section of the mentor profile of the selected mentor to reflect a relatively high score for video, online meetings, and emails and a relatively low score for texts, phone calls, and written materials. Likewise, the mentor feedback module 210 updates a timeliness section of the mentor profile of the selected mentor to reflect a degree of timeliness of responses and communications from the selected mentor.

The mentor feedback module 210, in some embodiments, updates a section of the mentor profile related to the skill where the mentee desires improvement. In some embodiments, the mentorship tracking module 208 provides one or more progress metrics that document progress of the mentee toward a goal, toward a certification, toward a desired skill level, and the like and the mentor feedback module 210 updates the mentor profile based on the progress metrics. For example, where the is seeking help to gain a certain number of followers on a social media account of the mentee, the mentorship tracking module 208 tracks progress toward the number of followers of the mentee’s social media account and the mentor feedback module 210 updates the mentor profile based on the progress toward the goal of social media followers.

Where the mentee is seeking mentorship to improve the mentee’s leadership abilities, the mentee and selected mentor may define certain goals or achievements using the mentorship tracking module 208 and the mentor feedback module 210 updates the mentor profile based on progress toward the goals or achievements. In some embodiments, the mentorship tracking module 208 provides a progress tool to establish goals, achievements, a progress timeline, or other metric for tracking accomplishments of the mentee and the mentor feedback module 210 interacts with the progress tool to determine progress for updating the mentor profile. Typically, progress metrics being tracked by the mentorship tracking module 208 are dependent on action of the mentee and the mentor feedback module 210, in some embodiments, updates the mentor profile based on effort of the mentor rather than progress of the mentee. One of skill in the art will recognize other ways for the mentor feedback module 210 to update the mentor profile based on interactions between the mentee and the selected mentor.

In some embodiments, the mentor feedback module 210 uses a mentor machine learning algorithm to update the mentor profile of each of a plurality of selected mentors based on feedback from the interactions between each of the plurality of selected mentors and a corresponding mentee. The mentor machine learning algorithm uses feedback from mentees and/or information about interactions between the mentees and corresponding selected mentors to refine information in each of the mentor profiles of the selected mentors. Over time the mentor machine learning algorithm uses interactions between various mentors and corresponding mentees along with other information, such as reviews from mentees, trends in the number of interactions, types of interactions, etc. to determine how much to change scores in various categories.

In some embodiments, the mentor machine learning algorithm uses a deep neural network with interactions as input. The mentor profiles include initial information that may come from the mentors. For example, a mentor may input a timeliness number, which may be inaccurate and the mentor feedback module 210 updates the timeliness scores in various mentor profiles. The mentor machine learning algorithm may determine over time and based on numerous updates to mentor profiles that an amount to update a mentor profile should be adjusted. In other embodiments, the mentor machine learning algorithm uses mentee feedback and other information to modify how much to weight various factors, how much to change category scores, etc. based on an ever growing number of interactions between mentees and corresponding mentors and feedback from mentees so that the mentor feedback module 210 more accurately updates mentor profiles.

FIG. 3 is a schematic block diagram illustrating another embodiment of an apparatus 300 for an intelligent mentor and expertise matching tool. The apparatus 300 includes another embodiment of the mentor apparatus 102 that includes a profile module 202, a scoring module 204, a selection module 206, a mentorship tracking module 208, and a mentor feedback module 210, which are substantially similar to those described above in relation to the apparatus 200 of FIG. 2. The apparatus 300, in various embodiments, includes a mentee survey module 302 and a mentor communication module 304 in the mentorship tracking module 208, a profile scraping module 306, a profile analysis module 308, a mentor identification module 310, a mentor request module 312 and/or a mentor profile module 314, which are described below.

In the apparatus 300, in some embodiments the mentorship tracking module 208 includes a mentee survey module 302 configured to present, via an electronic display of a computing device (e.g. client 114), a mentorship survey to the mentee regarding interactions between the mentee and the selected mentor. The mentor feedback module 210 uses the information provided by the mentee in response to receiving the mentee survey to update the mentor profile of the selected mentor. In some embodiments, the mentee survey module 302 presents a mentorship survey at various times during mentorship from the selected mentor. In other embodiments, the mentee survey module 302 presents a mentorship survey at a conclusion of the mentorship by the selected mentor.

Mentorship surveys include questions directed toward determining skill of the mentor, timeliness of communications from the mentor, types of communications, and other information useful for the mentor feedback module 210 in updating the mentor profile of the selected mentor. The mentorship surveys, in various embodiments, include questions that may be answered with a yes/no response, a sliding scale response, a response that include writing by the mentee, or other question type. In some embodiments, the mentee survey module 302 requires a response from the mentee to prevent termination of the mentorship, assessment of a fine, or other penalty to persuade the mentee to provide a response to mentorship surveys. In other embodiments, the mentee survey module 302 provides incentives to the mentee for filling out a mentorship survey, such as refunding fees for use of the mentor apparatus 102, an extension of mentorship hours, unlocking resources of the mentor apparatus 102, and the like.

In the apparatus 300, in some embodiments, the mentorship tracking module 208 includes a mentor communication module 304 configured to track frequency and content of interactions between the mentee and the selected mentor. The mentor feedback module 210 uses the frequency and the content of the interactions between the mentee and the selected mentor to update the mentor profile of the selected mentor. In some examples, where interactions go through the mentor apparatus 102, for instance through an interface provided to the mentee and an interface provided to the selected mentor, the mentor communication module 304 tracks the frequency and content of the interactions passing through the mentor apparatus 102. In other embodiments, the mentor communication module 304 accesses emails, texts, material in a folder of an operating system, etc. to track the frequency and the content of the interactions. For example, the mentor communication module 304 may gain access to electronic files, emails, etc. via permission and setup by the mentee and selected mentee. One of skill in the art will recognize other ways for the mentor communication module 304 to access interactions to track frequency and content of the interactions between the mentee and selected mentor.

The apparatus 300, in some embodiments, includes a profile scraping module 306 configured to further populate the mentee profile by scraping information from one or more social media accounts of the mentee. For example, once the mentee has interacted with the profile module 202 to set up an account, set up a profile, provide information, etc., the profile scraping module 306 accesses one or more social media accounts of the mentee to scrape information useful in populating the mentee profile. In some embodiments, the profile scraping module 306 interacts with the mentee to gain access to the social media accounts. In other embodiments, the profile scraping module 306 accesses publicly available information about the mentee on social media applications.

The apparatus 300, in some embodiments, includes a profile analysis module 308 configured to analyze mentee skills in one or more fields of study and/or one or more learning methods of the mentee from information in the mentee profile to identify a skill to be improved for the mentee and one or more preferred learning methods of the mentee. The scoring module 204 uses the identified skill to be improved for the mentee and the one or more preferred learning methods of the mentee for comparison with the mentor profiles.

In some examples, the profile analysis module 308 reviews courses completed by the mentee, certifications, test scores, and the like in a particular field of study to determine a skill level of the mentee in the particular field of study. For example, where the mentee seeks improvement as a financial advisor, the profile analysis module 308 may review financial certifications, course work in financial classes taken in college, test scores of courses, etc. to determine a skill level of the mentee as a financial advisor. The profile analysis module 308 then uses the skill level as input to the mentee profile of the mentee and the scoring module 204 uses the skill level when comparing the mentee profile with mentor profiles. The scoring module 204 may then provide a high score on a skill section of a mentor score where the mentor profile has a skill level higher than the skill level of the mentee.

In other embodiments, the profile analysis module 308 reviews input from the mentee, interactions with previous mentors, or other information relevant to learning methods to determine a score for one or more learning method categories in the mentee profile. For example, where the mentee profile includes categories of videos, emails, online meetings, phone calls, text messages, etc., the profile analysis module 308 analyzes information relevant to learning methods to determine a score for each learning method category. The scoring module 204 then compares similar categories of mentor teaching styles in mentor profiles when determining mentor scores for the mentor profiles. One of skill in the art will recognize other ways for the profile analysis module 308 to analyze mentee skills and/or learning methods to determine a skill level and/or one or more preferred learning methods for the mentee.

More mentor profiles in the mentor database 104 provides increased effectiveness for mentor apparatus 102 to match a mentee with a mentor. The apparatus 300 includes, in various embodiments, a mentor identification module 310 configured to identify potential mentors without a mentor profile in the mentor database 104. In various embodiments, the mentor identification module 310 uses recommendations from mentors and recommendations from mentees to identify potential mentors. In other embodiments, the mentor identification module 310 accepts input from a system administrator to identify potential mentors. In other embodiments, the mentor identification module 310 includes a scraping tool that crawls websites, databases, etc. available on the Internet, available on a LAN, to identify potential mentors. For example, the mentor identification module 310 may use the scraping tool to crawl social media sites to identify influencers in particular fields of interest.

In other embodiments, the mentor identification module 310 uses the scraping tool to crawl websites associated with a particular field of study to find potential mentors. For example, the mentor database 104 may be lacking in a particular field of study so the mentor identification module 310 searches websites of that particular field of study. In other embodiments, the mentor identification module 310 uses input from a system administrator, mentee, etc. to identify a particular field of study where more mentors are needed and the mentor identification module 310 uses the scraping tool to search websites associated with that field of study or other locations to identify potential mentors with an expertise in that field of study. One of skill in the art will recognize other ways for the mentor identification module 310 to identify potential mentors that do not yet have a mentor profile in the mentor database 104.

The apparatus 300, in some embodiments, includes a mentor request module 312 configured to send, over a computer network 116, an invitation to the potential mentor to be a mentor. In some embodiments, the mentor identification module 310 identifies contact information for the mentor request module 312 to use to send an invitation to the potential mentor. In other embodiments, the mentor request module 312 interacts with a mentee, a system administrator, or other person to get contact information of the potential mentor. In the embodiment, the mentor request module 312 notifies a system administrator, a mentee, or other person that a potential mentor has been identified and request input for the contact information.

In other embodiments, the mentor identification module 310 or mentor request module 312 searches public records, websites, etc. to find contact information for the potential mentor. In some embodiments, the mentor request module 312 creates a custom message relevant to a particular skill need within the mentor database 104 and present within the potential mentor to be part of the request to the potential mentor. In other embodiment, the mentor request module 312 solicits input from a system administrator, a mentee or other person to create a request to be sent to the potential mentor. In some embodiments, the mentor request module 312 includes in the request a way for the potential mentor to access the mentor apparatus 102 and to sign up as a mentor, to input information into a mentor profile, etc. One of skill in the art will recognize other ways for the mentor request module 312 to put together and send a request to a potential mentor to become a mentor available to mentees accessing the mentor apparatus 102.

The apparatus 300 includes, in some embodiments, a mentor profile module 314 configured to create a mentor profile in the mentor database 104 in response to receiving consent from the potential mentor. In some embodiments, the consent is merely a response to a query from the mentor request module 312 and does not include any additional information than the consent along with an identification of the potential mentor. In other embodiments, the potential mentor provides consent by establishing an account with the mentor apparatus 102. In other embodiments, the potential mentor also provides information to be included in a mentor profile. In other embodiments, a system administrator enters information into a mentor profile for the potential mentor based on a phone call, an email, or other form of communication between the potential mentor and the system administrator or other person authorized to enter data into the mentor profile.

The mentor profile is created from information about the potential mentor received from the potential mentor and/or publicly available information. In some embodiments, the potential mentor enters information directly into the mentor profile in the mentor database 104. In other embodiments, the potential mentor sends information and an authorized person enters the received information. In other embodiments, the mentor profile module 314 includes a data scraping tool that gathers information about the potential mentor from one or more social media accounts of the potential mentor. In other embodiments, the data scraping tool gathers other published or unpublished information about the potential mentor from one or more public and/or private websites.

In some embodiments, the mentor profile module 314 includes a mentor profile machine learning algorithm that refines information to be included in a mentor profile. In some examples, the mentor profile machine learning algorithm identifies locations and sources to identify locations on websites to find information to populate an education field in the mentor profile. In other embodiments, the mentor profile machine learning algorithm compares information provided from the data scraping tool with information in an approved mentor profile to refine the types of information and sources to search to find information that will be approved for a mentor profile. One of skill in the art will recognize other ways that the mentor profile machine learning algorithm can be tuned to use the data scraping tool to find information sources for a mentor profile and to populate a mentor profile from information provided by the potential mentor.

Beneficially, the mentor apparatus 102 described with regard to the apparatuses 200, 300 of FIGS. 2 and 3 provide a tool to match a mentor with a person desiring to be mentored. In addition, the mentor apparatus 102 tracks interaction between the mentee and a selected mentor to update a mentor profile of the selected mentor so that over time the mentor profile more accurately reflects the skills, quality of mentoring, teaching methods, etc. of the mentors with a mentor profile in the mentor database 104. In some embodiments, the mentor apparatus 102 uses machine learning to refine mentor profiles, mentee profiles, weighting factors, etc. to make the mentor apparatus 102 more useful and accurate.

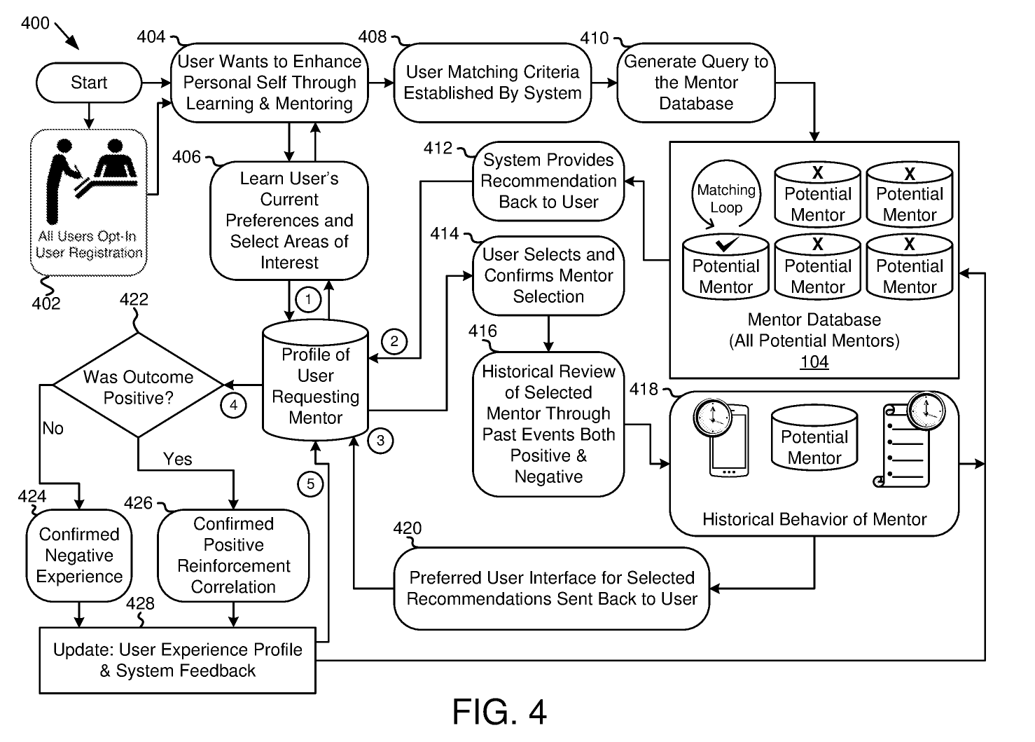

FIG. 4 is a schematic flow chart diagram illustrating one embodiment of a method 400 for an intelligent mentor and expertise matching tool. The method 400 starts and coordinates 402 with a user registration interface to receive information from a person that wants to find a mentor and be mentored by the mentor (e.g. the person is a “mentee”). Note that the mentee is identified as a “user” in FIG. 4. The method 400 identifies 404 what the user wants to enhance their personal self through learning and mentoring.

The method 400 learns 406 the user’s current preferences and selected areas of interest and establishes 408, from user input, matching criteria to match a mentor with the user and generates 410 a query to the mentor database 104. The mentor database 104 includes a plurality of mentor profiles of potential mentors and the query compares the user profile with the mentor profiles of potential mentors using a mentor scoring algorithm. For example, the user profile may indicate that the user want to increase the user’s skills in rock climbing. Mentor profiles, in some embodiments, that don’t include rock climbing skills are eliminated by the mentor scoring algorithm and other mentor profiles that indicate some rock climbing skills are included in the comparisons along with other skills that match what the user is seeking, such as experience with knots, outdoor experience, location of the potential mentor, mentor teaching styles, etc.

Once mentor scores are determined based on the comparison between the user profile and the mentor profiles, the mentoring apparatus (e.g. system) provides 412 one or more recommendations to the user and user selects 414 a mentor from the list of mentors presented 412 to the user. The method 400 reviews 416 interactions between the selected mentor and the user to determine 418 historical behavior of the selected mentor. From the historical behavior and other interactions, the method 400 presents 420 a user interface to the user with questions about recommendations from the user regarding the interactions between the user and the selected mentor.

The method 400 determines 422 whether the outcome of the user was positive or negative on various questions presented to the user. The method 400 confirms 424 a negative experience and/or confirms 426 positive reinforcement correlations on various topics, questions, subjects, etc. presented to the user as questions. The method 400 updates 428, from the mentor profile of the selected mentor based on the user experience profile, system feedback and the historical behavior (e.g. 418), and the method 400 ends. In various embodiments, all or a portion of the method 400 is implemented using one or more of the profile module 202, the scoring module 204, the selection module 206, the mentorship tracking module 208, the mentor feedback module 210, the mentee survey module 302, the mentor communication module 304, the profile scraping module 306 and/or the profile analysis module 308.

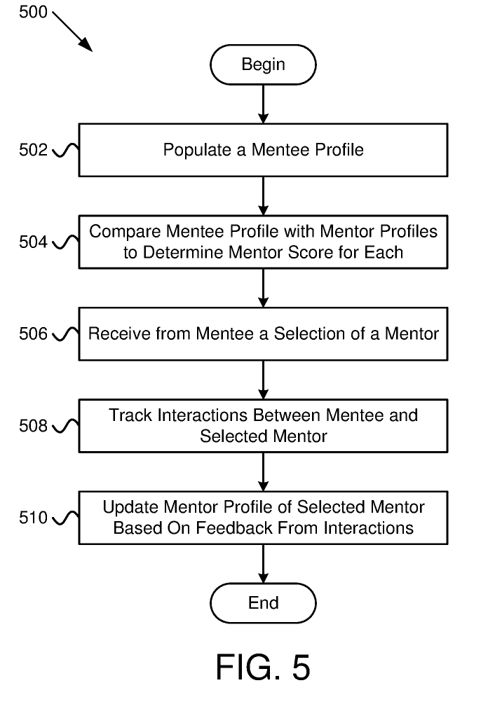

FIG. 5 is a schematic flow chart diagram illustrating another embodiment of a method 500 for an intelligent mentor and expertise matching tool. The method 500 begins and populates 502 a mentee profile of a mentee in response to receiving, via a computing device (e.g. client 114), information from the mentee. The mentee profile includes information about skills and preferences of the mentee. The method 500 compares 504 information from the mentee profile with a plurality of mentor profiles from a mentor database to determine, using a mentor scoring algorithm, a mentor score for each of the plurality of mentor profiles.

The method 500 receives 506, from the mentee via a computing device (e.g. client 114), a selection of a mentor from one or more mentors presented to the mentee. Each of the one or more mentors presented to the mentee has a higher mentor score than other mentors of the mentor database 104. The method 500 tracks 508 interactions between the selected mentor and the mentee and to updates 510 a mentor profile of the selected mentor based on feedback from the interactions between the selected mentor and the mentee, and the method 500 ends. In various embodiments, all or a portion of the method 500 is implemented using one or more of the profile module 202, the scoring module 204, the selection module 206, the mentorship tracking module 208, and the mentor feedback module 210.

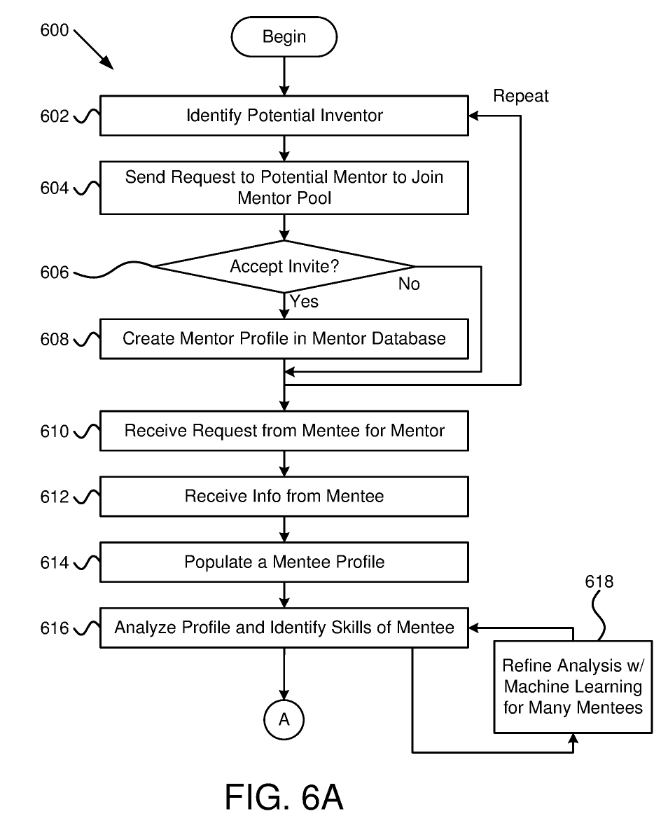

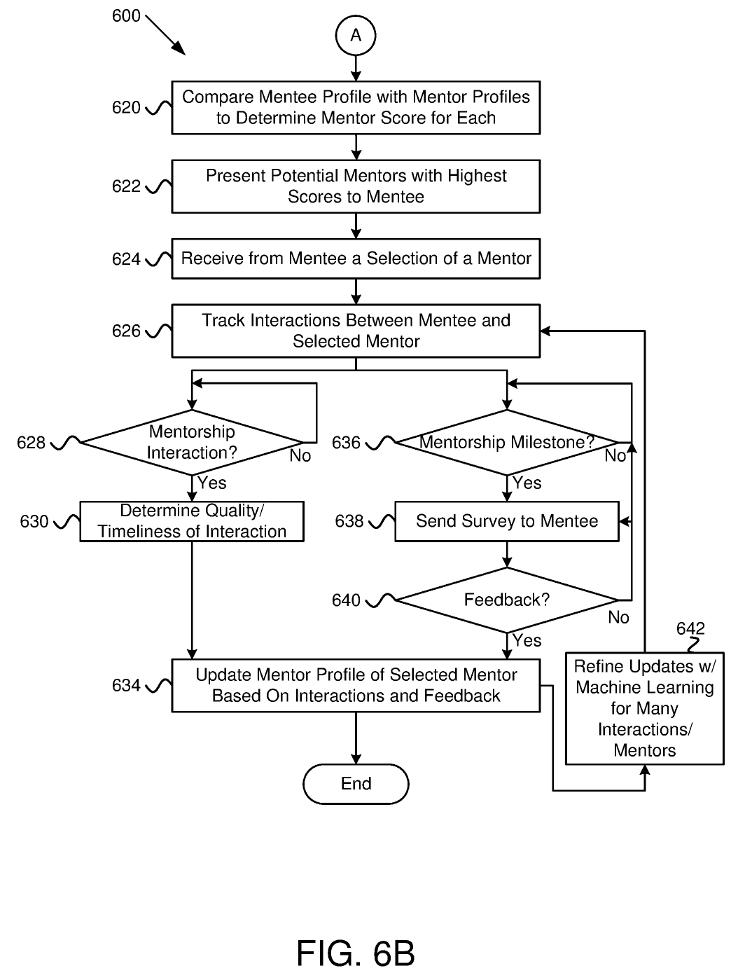

FIG. 6A is a first part and FIG. 6B is a second part of a schematic flow chart diagram illustrating a more detailed embodiment of a method 600 for an intelligent mentor and expertise matching tool. The method 600 begins and identifies 602 potential mentors that don’t have a mentor profile in the mentor database 104 and sends 604, over a computer network 116, an invitation to the potential mentor to be a mentor. The method 600 determines 606 if the potential mentor has accepted the invitation. If the method 600 determines 606 that the potential mentor has accepted the invitation, the method 600 creates 608 a mentor profile in the mentor database 104. The mentor profile is created from information about the potential mentor received from the potential mentor and/or publicly available information. If the method 600 determines 606 that the invitation was not accepted, the method 600 skips creating 608 a mentor profile. The method 600 repeats identifying 602 a potential mentor, sending 604 a request to the potential mentor, determining 606 if the invitation is accepted, and creating 608 a mentor profile for many potential inventors to create a mentor database 104 with many mentor profiles.

The method 600 receives 610 a request from a mentee to be matched with a mentor and receives 612 information from the mentee about a skill to be improved, preferred learning methods, a location of the mentee, contact information, and the like. Based on the information from the mentee, the method 600 populates 614 a mentee profile of a mentee and analyzes 616 mentee skills in one or more fields of study and/or one or more learning methods of the mentee from information in the mentee profile to identify a skill to be improved for the mentee and one or more preferred learning methods of the mentee. In some embodiments, the mentor profile clearly indicates a skill where the mentee wants improvement. In other embodiments, once a skill/field of study is identified, the method 600 analyzes 616 the mentee profile to determine a skill level of the mentee in the field of study, for example, from education, achievements, certificates, etc. of the mentee in the field of study.

In some embodiments, the method 600 uses 618 a mentee profile machine learning algorithm to refine over time analysis of the mentee skills and learning methods based on a plurality of mentee profiles, information from a plurality of mentees, and/or social media information from the plurality of mentees. The method 600 compares 620 (follow “A” on FIG. 6A to “A” on FIG. 6B) information from the mentee profile with a plurality of mentor profiles from a mentor database 104 to determine, using a mentor scoring algorithm, a mentor score for each of the plurality of mentor profiles. In some embodiments, the method 600 uses results of the analysis 618 of the mentee profile to compare with the mentor profiles.

The method 600 presents 622 potential mentors with highest mentor scores to the mentee, for example through an electronic display of a client 114. The method 600 receives 624, from the mentee via a computing device (e.g. client 114), a selection of a mentor from one or more mentors presented to the mentee and tracks 626 interactions between the selected mentor and the mentee. The method 600 determines 628 if there was interaction between the mentee and the selected mentor. If the method 600 determines 628 that there is no interaction between the mentee and the mentor, the method 600 returns to determine 628 if there is interaction between the mentee and the selected mentor. If the method 600 determines 628 that there is interaction between the mentee and the mentor, the method 600 determines 630 quality and timeliness of the interaction between the mentee, for example by analyzing time between interactions and content of the interaction and the method 600 updates 634 the mentor profile of the selected mentor based on the interactions.

The method 600 also determines 636 if there are any milestones in the mentorship of the mentee. A milestone includes completion of a task by the mentee, reaching a certain level of skill, or other indicator of progress of the mentee. In other embodiments, a milestone is a measure of time where the method 600 determines if a certain amount of time has passed since a previous milestone, since the beginning of the mentorship, etc. If the method 600 determines 636 that there have not been any milestones, the method 600 returns to determine 636 if the mentorship has reached any milestones. If the method 600 determines 636 that there has been a milestone, the method 600 sends 638 survey results to the mentee and determines 640 if feedback is received from the mentee. If the method 600 determines that there is no feedback from the mentee, the method 600 returns and determines 636 if there are any additional milestones and/or resends the survey to the mentee.

If the method 600 determines 640 that feedback is received from the mentee, the method 600 updates the mentor profile of the selected mentor using the feedback from the mentee, and the method 600 ends. In some embodiments, the method 600 uses 642 a mentor machine learning algorithm to update the mentor profile of each of a plurality of selected mentors based on feedback from the interactions between each of the plurality of selected mentors and a corresponding mentee. The mentor machine learning algorithm uses feedback from mentees and/or information about interactions between the mentees and corresponding selected mentors to refine information in each of the mentor profiles of the selected mentors. In various embodiments, all or a portion of the method 600 is implemented using one or more of the profile module 202, the scoring module 204, the selection module 206, the mentorship tracking module 208, the mentor feedback module 210, the mentee survey module 302, the mentor communication module 304, the profile scraping module 306, the profile analysis module 308, the mentor identification module 310, the mentor request module 312, and/or the mentor profile module 314.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An apparatus comprising:
a profile module configured to populate a mentee profile of a mentee in response to receiving, via a computing device, information from the mentee, the mentee profile comprising information about skills and preferences of the mentee;
a scoring module configured to compare information from the mentee profile with a plurality of mentor profiles from a mentor database to determine, using a mentor scoring algorithm, a mentor score for each of the plurality of mentor profiles;
a selection module configured to receive, from the mentee via a computing device, a selection of a mentor from one or more mentors presented to the mentee, each of the one or more mentors presented to the mentee comprising a higher mentor score than other mentors of the mentor database;
a mentorship tracking module configured to track interactions between the selected mentor and the mentee; and
a mentor feedback module configured to update a mentor profile of the selected mentor based on feedback from the interactions between the selected mentor and the mentee,
wherein at least a portion of said modules comprise one or more of hardware circuits, programmable hardware devices and executable code, the executable code stored on one or more non-transitory computer readable storage media.

2. The apparatus of claim 1, wherein each mentor profile in the mentor database comprises a plurality of mentor categories and each mentor category comprises a category score and the mentor feedback module updates the mentor profile based on feedback from the interactions between the selected mentor and the mentee by adjusting the category score in one or more of the plurality of mentor categories.

3. The apparatus of claim 2, wherein the category score of each of the mentor categories of a mentor profile affects the mentor score of the mentor profile when the scoring module compares a mentee profile with the mentor profile.

4. The apparatus of claim 1, wherein the mentorship tracking module further comprises a mentee survey module configured to present, via an electronic display of a computing device, a mentorship survey to the mentee regarding interactions between the mentee and the selected mentor, wherein the mentor feedback module uses the information provided by the mentee in response to receiving the mentee survey to update the mentor profile of the selected mentor.

5. The apparatus of claim 1, wherein the mentorship tracking module further comprises a mentor communication module configured to track frequency and content of interactions between the mentee and the selected mentor, wherein the mentor feedback module uses the frequency and the content of the interactions between the mentee and the selected mentor to update the mentor profile of the selected mentor.

6. The apparatus of claim 1, further comprising a profile scraping module configured to further populate the mentee profile by scraping information from one or more social media accounts of the mentee.

7. The apparatus of claim 1, further comprising a profile analysis module configured to analyze mentee skills in one or more fields of study and/or one or more learning methods of the mentee from information in the mentee profile to identify a skill to be improved for the mentee and one or more preferred learning methods of the mentee, wherein the scoring module uses the identified skill to be improved for the mentee and the one or more preferred learning methods of the mentee for comparison with the mentor profiles.

8. The apparatus of claim 7, wherein the scoring module uses preferences from the mentee and the identified skill to be improved for the mentee and the one or more preferred learning methods of the mentee to adjust weighting of the information of the mentee profile.

9. The apparatus of claim 7, wherein the profile analysis module uses a mentee profile machine learning algorithm to refine over time analysis of the mentee skills and learning methods based on a plurality of mentee profiles, information from a plurality of mentees, and/or social media information from the plurality of mentees.

10. The apparatus of claim 1, wherein the mentee profile and the mentor profiles each comprise location information and the scoring module uses the location information in determining a mentor score for each of the plurality of mentor profiles.

11. The apparatus of claim 1, wherein the mentor feedback module uses a mentor machine learning algorithm to update the mentor profile of each of a plurality of selected mentors based on feedback from the interactions between each of the plurality of selected mentors and a corresponding mentee, wherein the mentor machine learning algorithm uses feedback from mentees and/or information about interactions between the mentees and corresponding selected mentors to refine information in each of the mentor profiles of the selected mentors.

12. The apparatus of claim 1, further comprising:
a mentor identification module configured to identify potential mentors without a mentor profile in the mentor database;
a mentor request module configured to send, over a computer network, an invitation to the potential mentor to be a mentor; and
a mentor profile module configured to create a mentor profile in the mentor database in response to receiving consent from the potential mentor, wherein the mentor profile is created from information about the potential mentor received from the potential mentor and/or publicly available information.

13. A computer-implemented method comprising:
populating, using a processor, a mentee profile of a mentee in response to receiving, via a computing device, information from the mentee, the mentee profile comprising information about skills and preferences of the mentee;
comparing, using a processor, information from the mentee profile with a plurality of mentor profiles from a mentor database to determine, using a mentor scoring algorithm executing on the processor, a mentor score for each of the plurality of mentor profiles;
receiving, from the mentee via a computing device, a selection of a mentor from one or more mentors presented to the mentee, each of the one or more mentors presented to the mentee comprising a higher mentor score than other mentors of the mentor database;
tracking, using a processor, interactions between the selected mentor and the mentee; and
updating, using a processor, a mentor profile of the selected mentor based on feedback from the interactions between the selected mentor and the mentee.

14. The computer-implemented method of claim 13, wherein each mentor profile in the mentor database comprises a plurality of mentor categories and each mentor category comprises a category score and updating a mentor profile of the selected mentor based on feedback from the interactions between the selected mentor and the mentee comprises adjusting the category score in one or more of the plurality of mentor categories, wherein the category score of each of the mentor categories of a mentor profile affects determining a mentor score.

15. The computer-implemented method of claim 13, wherein tracking interactions between the selected mentor and the mentee further comprises:
presenting, via an electronic display of a computing device, a mentorship survey to the mentee regarding interactions between the mentee and the selected mentor, wherein updating a mentor profile of the selected mentor further comprises using the information provided by the mentee in response to receiving the mentee survey to update the mentor profile of the selected mentor; and/or
tracking frequency and content of interactions between the mentee and the selected mentor, wherein updating a mentor profile of the selected mentor further comprises using the frequency and the content of the interactions between the mentee and the selected mentor to update the mentor profile of the selected mentor.

16. The computer-implemented method of claim 13, further comprising analyzing mentee skills in one or more fields of study and/or one or more learning methods of the mentee from information in the mentee profile to identify a skill to be improved for the mentee and one or more preferred learning methods of the mentee, wherein determining the mentor score further comprises using the identified skill to be improved for the mentee and the one or more preferred learning methods of the mentee for comparison with the mentor profiles.

17. The computer-implemented method of claim 16, further comprising using a mentee profile machine learning algorithm to refine over time analysis of the mentee skills and learning methods based on a plurality of mentee profiles, information from a plurality of mentees, and/or social media information from the plurality of mentees.

18. The computer-implemented method of claim 13, wherein updating a mentor profile of the selected mentor comprises using a mentor machine learning algorithm to update the mentor profile of each of a plurality of selected mentors based on feedback from the interactions between each of the selected mentors and a corresponding mentee, wherein the mentor machine learning algorithm uses feedback from mentees and/or information about interactions between the mentees and corresponding selected mentors to refine information in each of the mentor profiles of the selected mentors.

19. A computer program product for mentor selection, the computer program product comprising a non-transitory computer readable storage medium having program instructions embodied therewith, the program instructions executable by a processor to cause the processor to:
populate a mentee profile of a mentee in response to receiving, via a computing device, information from the mentee, the mentee profile comprising information about skills and preferences of the mentee;
compare information from the mentee profile with a plurality of mentor profiles from a mentor database to determine, using a mentor scoring algorithm executing on the processor, a mentor score for each of the plurality of mentor profiles;
receive, from the mentee via a computing device, a selection of a mentor from one or more mentors presented to the mentee, each of the one or more mentors presented to the mentee comprising a higher mentor score than other mentors of the mentor database;
track interactions between the selected mentor and the mentee; and
update a mentor profile of the selected mentor based on feedback from the interactions between the selected mentor and the mentee.

20. The computer program product of claim 19, wherein each mentor profile comprises a plurality of mentor categories and each mentor category comprises a category score and updating a mentor profile of the selected mentor based on feedback from the interactions between the selected mentor and the mentee comprises adjusting the category score in one or more of the plurality of mentor categories, wherein the category score of each of the mentor categories of a mentor profile affects determining the mentor score.
